(19) United States
(12) Patent Application Publication
(10) Pub. No.: US 2006/0051389 A1
(43) Pub. Date: Mar. 9, 2006

(54) Sustained release polymer-based water insoluble beads

(75) Inventors: Arnon Shani, Omer (IL); Shlomo Magdassi, Jerusalem (IL); Ido Yosha, Mobile Post Hanegev (IL)

Correspondence Address: LADAS & PARRY, 26 WEST 61ST STREET, NEW YORK, NY, 10023, US

(73) Assignees: BEN GURION UNIVERSITY OF THE NEGEV, RESEARCH AND DEVELOPMENT AUTHORITY; YISSUM RESEARCH DEVELOPMENT COMPANY OF THE HEBREW UNIVERSITY OF JERUSALEM

(21) Appl. No.: 11/250,027

(22) Filed: Oct. 13, 2005

Related U.S. Application Data
(62) Division of application No. 09/856,795, filed on Aug. 14, 2001.

(30) Foreign Application Priority Data
Dec. 3, 1998 (IL) 127396

(51) Int. Cl. A01N 25/26; A01N 25/28

(52) U.S. Cl. 424/418

(57) ABSTRACT

The invention provides a sustained release, polymer-based, water insoluble bead, comprising a polymeric matrix containing a plurality of emulsion droplets, said droplets being formed from at least one surface active molecule, at lease one volatile hydrophobic component and water, wherein said volatile component is released from said water insoluble bead in atmospheric air.

The present invention relates to a sustained release dispersion of water insoluble beads and to a process for the preparation thereof. More particularly, the present invention relates to a sustained release dispersion of water insoluble beads each bead comprising a polymeric matrix comprised of a protein and a polysaccharide and containing at least one volatile hydrophobic component for release therefrom in atmospheric air.

U.S. Pat. Nos. 4,400,391 and 4,401,456 describe and claim alginate gel beads containing bioactive materials dispersed therein. These beads can be made to either float or sink in aqueous environments, and are capable of providing the controlled release of their bioactive materials when applied to terrestrial or aqueous environments.

The prior art deals with the controlled and/or sustained release of various materials from polysaccharide beads such as from alginate gel beads into aqueous or wet environments, however the release of hydrophobic volatile materials into the atmosphere from such a bead is neither taught nor suggested in the prior art.

With this state of the art in mind, there is now provided according to the present invention a sustained release dispersion of water insoluble beads, each bead comprising a polymeric matrix comprised of a protein and a polysaccharide and containing a plurality of emulsion droplets, said droplets being formed from at least one surface active molecule, at lease one volatile hydrophobic component and water, wherein said volatile component is released from said water insoluble bead in atmospheric air.

In especially preferred embodiments of the present invention, said polysaccharide is selected from the group consisting of sodium alginate, carraggenan, guar gum, locus bean gum, chitosan, pectin carboxy methyl cellulose.

In other preferred embodiments of the present invention, said protein is selected from the group consisting of gelatin, albumin, casein and Lactoglobulin.

In preferred embodiments of the present invention said surface active molecule is selected from the group consisting of a protein, a monomeric surfactant and a polymeric surfactant.

In especially preferred embodiments of the present invention, said surface active molecule is selected from the group consisting of ethoxylated sorbitan ester, aklyl ether, a block copolymer and geletin. Preferably, said bead is of a size between 0.5 micron and 1 mm and especially preferred are beads of a size between 5 and 80 microns.

In preferred embodiments of the present invention said volatile component is an attractant which is preferably selected from the group consisting of eugenol, benzyl alcohol, leaf alcohols, aldehydes and acetates.

In other preferred embodiments of the present invention said volatile component is an attractant inhibitor which is preferably selected from the group consisting of (Z)-9-tetradecenyl formate and (E,E)-10,12-hexadecadienol.

In another aspect of the present invention there is now provided a process for preparing sustained-release polymer-based water insoluble beads for release of a volatile hydrophobic component therefrom in atmospheric air, comprising:
a) preparing an oil/water emulsion by homogenizing a volatile hydrophobic component in water, using at leas one surface active molecule;
b) mixing said emulsion with at least one water-soluble polymer and optionally rehomogenizing the mixture; and
c) adding the emulsion prepared in step (b) in a dropwise manner into a gellant solution to form said water insoluble beads.

In preferred embodiments of the present invention said process further comprises the step of chemically cross-linking polymers present in said composition and further comprises the step of drying said beads.

The beads prepared by the process of this invention are useful in providing sustained release of volatile materials contained therein, when exposed to the atmosphere. As long as the dispersion of beads are kept in water, the volatile material is not released.

Said oil in water emulsion is preferably prepared by homogenization of the volatile hydrophobic component in a gelatin solution. A water-soluble salt of alginic acid is mixed with water and added to the solution. The mixture is then homogenized again, and added dropwise into an aqueous solution of di-, tri- or quatra-valent metal salt (called the gellant solution) that will cause the alginate to form gel. As each drop comes in contact with the metal salt solution, the gelation is initiated and a bead forms. Further treatment of the water insoluble beads with tannic acid solution over night is possible if an extended delay of the release of the volatile material is desired.

More particularly, the invention describes the process and the product, which is the formulation for a slow release of pheromones.

The abstract of JP 58 121212 (D1) discloses a gel like body for sustained release of a volatile substance. The polymer is comprised of sodium polyacrylate having at least one epoxy group per molecule and a cationic surfactant. The resulting gel like body which is composed of synthetic polymers is different from the polymeric beads of the present invention, which are based on biopolymers, proteins and polysaccharide. The use of biopolymers has significant advantages based on environmental considerations.

GB 2,129,302 (D2) describes a method of treating a ground area with a substance which is dispersed within a polymeric material. The method of preparation of the product described therein is completely different from that of the present invention and is based on polymerization of synthetic monomers, which forms a large body of polymeric material, which has to be sliced or diced or otherwise divided into small particles. In contradistinstinction the present invention deals only with biopolymers and the cross-linking of polymers which were already formed by multivalent electrolytes leading to small particles. In addition, since this method is based on chemical reaction, the monomers may react with the active substance.

U.S. Pat. No. 4,401,456 (D3) describes a method for preparing alginate beads containing bioactive material, which mainly is released by leaching. The beads do not contain, as in the present invention, a protein, in addition to the alginate and said patent suggests only the use of alginate and not the use of other polysaccharides.

GB 2,141,932 (D4) discloses pest control composition based on a pheromone in a liquid or semi-liquid polymeric water resistant matrix allowing sustained release of the pheromone. Unlike the present invention, the composition is not based on beads, does not contain water and surfactant, and is based on synthetic polymers.

EP 0 617 051 describes polymeric compositions for controlled release of substances, in the form of emulsions which are used for impregnation or coating articles. In said Patent, unlike the present invention, the polymers are synthetic and the active substance is in direct contact with the monomers and therefore may react with the monomers and lose it's activity.

In Journal of Economic Entomology, 82(6), 1 Dec. 1989, pages 1830-1835, Meinke L J et al: describes a pheromone delivery system which is encapsulated in a starch borate matrix. The formulation is completely different than the compositions described in the present invention.

### DETAILED DESCRIPTION OF THE PRESENT INVENTION

In substantial similarity to U.S. Pat. No. 4,401,456, the simplicity of requirements needed for carrying out the process of the present invention permits much latitude in design of equipment. A suitable apparatus, as described below, is brought only for the purpose of illustration and not to be construed as limiting the invention. The apparatus consists of a reservoir to contain the alginate/protein/volatile- material/water emulsion that is equipped with a stopcock or similar device that allows the dropwise addition of the mixture through an orifice. The gellant solution may be contained in any convenient vessel.

After a suitable amount of time within the gellant solution, the resulting gel beads are removed by means such as filtration, screening, or straining. They may be rinsed in plain water if desired.

Beads may be further stirred in tannic acid solution and then rinsed again if a longer release-time of the volatile material is desired

The beads can be used in this fully hydrated state or dried to any desired moisture content without losing their effectiveness. Small hard granules result when the beads are dried. The hydrophobic oil which is present within the beads, e.g. a pheromone, can be released slowly, to the atmosphere. The rate of release can be sustained by suitable selection of the concentration of the alginate, proteins, tannic acid and additional components such as polyethylene glycol, urea and electrolytes.

The rate of addition of the mixture from the reservoir is a function of orifice size and the number of orifices used. The above rate can be increased by applying air or piston pressure.

The distance between the orifice and the surface of the gellant solution should be far enough to allow the droplet to penetrate the surface of the gellant solution.

The size of the resulting alginate gel beads depends on the viscosity of the alginate/volatile material/water mixture, the amount of water retained in the beads, and orifice size. An orifice of 0.1-5 mm in diameter is suitable, but the preferred range is 0.8-2 mm. Beads will be generally spherical or ellipsoidal with an average diameter of 0.1-6 mm. Smaller beads, down to micron in size, may be prepared by spraying the alginate/volatile material/water mixture into the gellant bath.

A continuous process of producing beads is possible and requires continuous removal of gel beads and maintenance of the gellant concentration. It is also possible to extrude the alginate/volatile- material/water mixture into the gellant to form a string-like gel, which can be cut into various lengths or dried and ground into granules.

Hydrated (undried) beads will usually be stored in water. The well-known phenomenon of syneresis can occur with alginate gels as well as with many other polysaccharide gels. Specifically, it is the loss of fluid (mostly water in the present invention), from the gel caused by contraction. Most of the fluid loss occurs within the 24-hour period after preparation, but it can continue for a few weeks before coming to equilibrium. Some factors that influence the amount of syneresis are alginate composition, cross-linking of the gelatin with tannic acid, temperature, gellant and the chemical nature of the volatile material. Usually the fluid that is exuded during the first 36 hours, is principally water and only a relatively small amount of volatile material is lost.

The protein used in the emulsion preparation of the present invention is a B type gelatin, but other proteins may be used as well. The concentration of the protein may vary widely and will influence the release rate of the volatile component/s.

The alginates used in the invention are any water-soluble salts of alginic acid. These include sodium, potassium, magnesium and ammonium alginate, and the alginates of organic bases such as amines. Sodium alginate is preferred. The viscosity of the alginate may vary and will influence gel strength to some degree. Highly refined alginates are not required for the practice of this invention.

An especially preferred alginate is the alginic acid, sodium salt, LX0450, available from MCB Manufacturing Chemists Inc., Cincinnati, Ohio, having a bulk density of 43 lbs./cu ft, a pH of 7.2 in a 1% aqueous solution, and a viscosity (run with a Brookfield LVF @ 60 RPM) of 400 @ 1% and 3500 @ 2%.

Concentration of the alginate formulated in the initial alginate/volatile material/water mixture is 0.1-3% by weight, but 1-1.5% is usually preferred. The volatile materials referred to in this invention are any volatile bioactive materials, such as pheromones, essential oils, pesticides, fragrances, etc.

The excellent chemical compatibility of alginates allows admixture according to the present invention with a very wide choice of volatile materials such as those described above. They are too numerous to list in their entirety. The following are only a few of the pheromones that can be used, given for the purpose of illustration and should not be construed as limiting the scope of the invention. The common name is given first, followed by the chemical name.

| Common name | Chemical name |
|---|---|
| Muscamone | (Z)-9-tricosene |
| Gossyplure | (ZZ)-7,11-hexadecadien-1-ol acetate, and |
| | (Z,E)-7,11-hexadecadien-1-ol acetate |
| Disparlure | cis-7,8-epoxy-2-methyloctadecane |
| Grandlure | (1R-cis)-1-methyl-2-(l-methylethenyl cyclobutaneethanol; |
| | (Z)-2-(3,3-dimethylcyclohexylidene)ethanol |
| | (Z)-(3,3-dimethylcyclohexylidene)acetaldehyde; and |
| | (E)-(3,3-dimethyicyclohexylidene)acetaldehyde |

It is an important part of this invention that additional control over rate of release of these types of volatile materials may be achieved. This may be achieved by interaction between the components of the formulation with the active materials.

Concentration of the volatile material formulated in the alginate/protein/volatile material/water mixture can be as high as 50% by weight, but is preferably in the range of 0.1-20%. The ingredients of this mixture may be incorporated in any order desired prior to the emulsification process. The preferred pH range of the mixture is 4-12. The usual and preferred temperature of the mixture is 20-30° C., but may be higher to reduce viscosity.

Cations that will gel alginate solutions are the cations of barium, lead, copper, iron, strontium, cadmium, calcium, zinc, nickel, aluminum, tin, acid (H⁺), and mixtures of these. The gellant solution of the present invention consists of an aqueous solution of a soluble and ionized salt of a metal listed above, an acid, or a mixture of these. Choice of gellant will have an effect on gel properties and possibly on the release rate of the volatile material dispersed in the alginate gel bead. The preferred gellants are the chlorides and acetates of calcium, barium and copper; the preferred acids are hydrochloric and acetic. Concentration of the metal salt or acid in the gellant solution may be up to 50% by weight, though 1-15% is preferred. Gelation proceeds faster as the concentration is increased. Reaction with sodium alginate and certain volatile materials will reduce the effective concentration of gellant cations, therefore a sufficient concentration must be maintained to provide the desired properties.

Temperature of the gellant solution can affect gel properties. It is an advantage of the present invention, which involve volatile materials that heat does not have to be employed and most products can be made at 1-30° C. The preferred range is 20-30° C. However, any temperature up to, and including, the boiling point of the gellant solution may be used. Reaction of the alginate/volatile material/water mixture with the gellant solution is very rapid and produces a distinct gel bead immediately. Gelation proceeds from the outer surface to the center of the bead. Final gel properties such as hardness, pore size, surface area, strength, elasticity, size, durability, and release rate of the volatile material are influenced by the time within the gellant solution and should be optimized for each product. Generally, a residence time of 0.1-25 minutes may be used, but 1-10 minutes is usually sufficient.

In certain applications it may be desirable to add other ingredients to the alginate/volatile material/water mixture or to the gellant solution, or to the final gel beads. These additives may serve to alter the rate of release of the volatile material, protect the gel beads from microbial attack or oxidation, facilitate the preparation process or reduce syneresis. They include solubilizing agents, biocides such as formaldehyde, enzymes, organic solvents, surfactants, viscosity modifiers, filmforming agents, natural and synthetic gums, sequestering agents, starch, talc, fibers, light-screening chemicals and antioxidants.

Sustained release refers to formulations or materials that dispense their active ingredients into the environment over a period of time in a constant rate. For the purpose of this invention this time period can be short and measured in minutes or hours, or long and measured in days or even months. In the present invention, release of the volatile material from the alginate beads occurs through processes such as leaching, diffusion, dissolution, and degradation in atmospheric air.

Sustained release materials may be used to reduce the number of applications needed to perform a certain task, permit an effective (while not too high) concentration in the environment at any one time, and enhance effectiveness against the target species.

This invention is suitable for producing alginate gel beads containing volatile material, said beads being useful for agricultural, industrial, domestic and health-related purposes.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLE 1

3 grams of gelatin type B were dissolved in 97 grams of water. 5 grams of dodecyl acetate and 3.4 grams of water were added to 16.6 grams of the solution, and the mixture was homogenized for 5 minutes (9500 R.P.M). 2 grams of sodium alginate were dissolved in 98 grams of water, and 25 grams of the solution were added to the solution of gelatin and dodecyl acetate. The whole mixture was homogenized for 5 minutes (9500 R.P.M).

The solution was added dropwise through a syringe equipped with a 22G×1 ½ needle, failing a distance of 60 mm, into 150 ml of 1% CaCl₂ solution. The CaCl₂ solution was contained in a 150 mm diameter vessel, and stirred with a magnetic stirrer in a rate of about 120 R.P.M. The rate of addition was such that 5 minutes were required for the 50 g addition to take place. The beads formed (2 mm idiameter) were left in the solution for 5 additional minutes. The beads were then separated by filtration through a sieve, washed in water and stored in water. When air-dried, the beads became hard granules of about 1 mm in diameter. Release rate was measured—see sample A in Table 1.

### EXAMPLE 2

Beads were made in the same manner as in example 1, using CaCl₂ 0.25% as the gellant solution.

Release rate was measured—see sample B in Table 1.

### EXAMPLE 3

Beads were made in the same manner as in example 1, using CaCl₂ 0.1% as the gellant solution.

Release rate was measured—see sample C in Table 1.

### EXAMPLE 4

Beads were made in the same manner as in example 1, with 1% gelatin as the protein.

Release rate was measured—see sample D in Table 1.

### EXAMPLE 5

Beads were made in the same manner as in example 1, with 0.5% gelatin as the protein.

Release rate was measured—see sample E in Table 1.

### EXAMPLE 6

Beads were made in the same manner as in example 1, with 0.6% alginate.

Release rate was measured—see sample F in Table 1.

### EXAMPLE 7

Alginate beads containing dodecyl acetate were prepared as in example 1, but using FeCl₃ as the gellant solution.

### EXAMPLE 8

Alginate beads containing dodecyl acetate were prepared as in example 1, but using SnCl₄ as the gellant solution.

### EXAMPLE 9

Alginate beads containing dodecyl acetate were prepared as in example 1, but the beads formed were left over night in a 1% tannic acid solution. The beads were then washed in water and stored in water.

Release rate was measured—see sample G in Table 1.

### EXAMPLE 10

3 grams of gelatin were dissolved in 97 grams of water. 5 grams of Gossyplure (Pink Bollworm pheromone) and 3.4 grams of water were added to 16.6 grams of the solution, and the mixture was homogenized for 5 minutes (9500 R.P.M). 2 grams of sodium alginate were dissolved in 98 grams of water, and 12.5 grams of the solution were added to the solution of gelatin and Gossyplure. The whole mixture was homogenized for 5 minutes (9500 R.P.M). The resulting emulsion was processed as in example 1 to produce alginate gel beads containing Gossyplure.

Release rate was measured—see sample H in Table 1 and FIG. 1.

### EXAMPLE 11

3 grams of gelatin were dissolved in 97 grams of water. 5 grams of Eugenol and 3.3 grams of water were added to 16.6 grams of the solution, and the mixture was homogenized for 5 minutes (9500 R.P.M). 3 grams of sodium alginate were dissolved in 97 grams of water, and 25 grams of the solution were added to the solution of gelatin and Eugenol. The whole mixture was homogenized for 5 minutes (9500 R.P.M).

The solution was added dropwise through a syringe equipped with a 18G×1 ½ needle, falling a distance of 500 mm, into 150 ml of 0.25% CaCl₂ solution. The CaCl₂ solution was contained in a 150 mm diameter vessel, and stirred with a magnetic stirrer in a rate of about 120 R.P.M. The rate of addition was such that 5 minutes were required for the 50 g addition to take place. The beads formed (2 mm in diameter) were left in the solution for 5 additional minutes. The beads were then separated by filtration through a sieve, washed in water and left overnight in a 1% tannic acid solution. The beads were then washed and stored in water. When air-dried, the beads became hard granules of about 0.5 mm in diameter. Release rate was measured—see sample I in Table 1.

### EXAMPLE 12

Beads were made from an emulsion of 10% Eugenol, 1% gelatin and 1.5% alginate, in the same manner described above. The beads were placed in traps that were placed in a peanut-field. Together with these traps, reference traps that contained live virgin females of the beetle Maladera Matrida Argaman were placed in the field. After ten days, the traps containing the eugenol beads trapped as many beetles as the traps with the live females.

### EXAMPLE 13

Beads were made from an emulsion of 10% pheromone of the Pink Bollworm moth, 1% gelatin and 1% alginate, in the same manner described above. The beads were placed in bags, containing 200 mg of dry beads each. 25 bags were placed in a cotton field, forming a square of 50×50 meters. Reference traps containing pheromone impregnated in cardboard were placed in the middle of the square and in the field, away from the experiment. In a 43 day period, the reference traps in the field around the experiment trapped much more moths than the trap in the middle of the square as described in Table 2 hereinafter:

### EXAMPLE 14

3 grams of gelatin Type B 75 Bloom were dissolved in 97 grams of water. 5 grams of pink bollworm pheromone and 3.4 grams of water were added to 16.6 grams of the solution, and the. mixture was homogenized for 5 minutes (9500 R.P.M). 2 grams of sodium alginate were dissolved in 98 grams of water, and 25 grams of the solution were added to the solution of gelatin and dodecyl acetate. The whole mixture was homogenized for 5 minutes (9500 R.P.M). The solution was sprayed through an atomizer (BETE fog nozzle FC7, ¼ XA, cap AC1201) into 150 ml of 1% CaCl₂ solution. The CaCl₂ solution was contained in a 150 mm diameter vessel, and stirred with a magnetic stirrer in a rate of about 120 R.P.M. The rate of spraying was such that few seconds were required for the 50 g addition to take place. The beads formed (0.01-0.3 mm in diameter) were left in the solution for 5 additional minutes. The beads were then separated by filtration through a sieve, washed in water and stored in water. When dried in room temperature, the beads became hard granules of about 0.005-0.15 mm in diameter. Release rate was measured outdoors over prolonged period of time, and it was found that the formulation yields a slow release of the volatile hydrophobic component. The amounts released were as described in Table 3, and in sample J in Table 1.

### EXAMPLE 15

Micron-size particles were prepared as in example 14, but using gelatin Type B 225 Bloom as the protein.

The sprayable formulation (micron size particles in 50 ml of water) was added to 15 L of water and sprayed in a cotton field using a backpack sprayer. Release rate was measured outdoors over prolonged period of time, and it was found that the formulation yields a slow release of the volatile hydrophobic component. The amounts released were as described in Table 3, and in sample K in Table 1.

Reference traps containing pheromone impregnated in cardboard were placed in the middle of the square and in the field, away from the experiment. In a 21 days period, the reference traps in the field around the experiment trapped much more moths than the trap in the middle of the square as described in Table 4.

### EXAMPLE 16

3 grams of gelatin type B 75 Bloom were dissolved in 97 grams of water. 5 grams of Codling moth pheromone and 3.4 grams of water were added to 16.6 grams of the solution, and the mixture was homogenized for 5 minutes (9500 R.P.M). 24 grams of acrylate solution (Joncryl SCX 8089) were dissolved in 6 grams of water, and 25 grams of the solution were added to the solution of gelatin and pheromone. The whole mixture was homogenized for 5 minutes (9500 R.P.M). The solution was added dropwise through a syringe equipped with a 22G×1 ½ needle, falling a distance of 60 mm, into 150 ml of 5% CaCl₂ solution. The CaCl₂ solution was contained in a 150 mm diameter vessel, and stirred with a magnetic stirrer in a rate of about 120 R.P.M The rate of addition was such that 5 minutes were required for the 50 g addition to take place. The beads formed (2 mm in diameter) were left in the solution for 5 additional minutes. The beads were then separated by filtration through a sieve, washed in water and stored in water. When air-dried, the beads became hard granules of about 1 mm in diameter.

### EXAMPLE 17

Beads were made in the same manner as in example 1, using Codling moth pheromone.

### EXAMPLE 18

An emulsion was made in the same manner as in example 16. The emulsion was added to a gellant solution of CaCl₂ 5% using a spraying device as in Example 14, to form micron size particles.

### EXAMPLE 19

An emulsion was made in the same manner as in example 16 and added dropwize to 150 ml of glacial acetic acid to form beads of around 2 mm in diameter. The beads were left in the acid for about 5 minutes and then filtered and washed thoroughly with water to remove the acid.

### EXAMPLE 20

An emulsion was made in the same manner as in example 16. The emulsion was added to a glacial acetic acid using a spraying device as in example 14, to form micron size particles. The particles were left in the acid for few minutes and then filtered and washed with water and kept wet in water.

### EXAMPLE 21

0.5 g of Tween 80 were added to 5 grams of Codling- moth pheromone and 19.5 grams of water, and the mixture was homogenized for 5 minutes (9500 R.P.M). 2 g of sodium aiginate were dissolved in 98 grams of water, and 25 grams of the solution were added to the emulsion of the pheromone and Tween 80. The whole mixture was homogenized for 5 minutes (9500 R.P.M). The solution was added dropwise through a syringe equipped with a 22G×1 ½ needle, falling a distance of 60 mm, into 150 ml of 5% CaCl₂ solution. The CaCl₂ solution was contained in a 150 mm diameter vessel, and stirred with a magnetic stirrer in a rate of about 120 R.P.M. The rate of addition was such that 5 minutes were required for the 50 g addition to take place. The beads formed (2 mm in diameter) were left in the solution for 5 additional minutes. The beads were then separated by filtration through a sieve, washed in water and stored in water. When air-dried, the beads became hard granules of about 1 mm in diameter.

### EXAMPLE 22

An emulsion was made in the same manner as in example 21. The emulsion was added to a gellant solution of CaCl₂ 1% using a spraying device as in example 14, to form micron size particles.

### EXAMPLE 23

0.5 g of Tween 80 were added to 5 grams of Codling- moth pheromone and 19.5 grams of water, and the mixture was homogenized for 5 minutes (9500 R.P.M). 24 grams of acrylate solution (Joncryl SCX 8089) were dissolved in 6 grams of water, and 25 grams of the solution were added to the solution of Tween 80 and pheromone. The whole mixture was homogenized for 5 minutes (9500 R.P.M). The solution was added dropwise through a syringe equipped with a 22G×1 ½ needle, falling a distance of 60 mm, into 150 ml of 5% CaCl₂ solution. The CaCl₂ solution was contained in a 150 mm diameter vessel, and stirred with a magnetic stirrer in a rate of about 120 R.P.M. The rate of addition was such that 5 minutes were required for the 50g addition to take place. The beads formed (2 mm in diameter) were left in the solution for 5 additional minutes. The beads were then separated by filtration through a sieve, washed in water and stored in water. When air-dried, the beads became hard granules of about 1 mm in diameter.

### EXAMPLE 24

An emulsion was made in the same manner as in example 23. The emulsion was added to a gellant solution of CaCl₂ 5% using a spraying device as in example 14, to form micron size particles.

### EXAMPLE 25

An emulsion was made in the same manner as in example 23 and added dropwise to 150 ml of glacial acetic acid to form beads of around 2 mm in diameter. The beads were left in the acid for about 5 minutes and then filtered and washed thoroughly with water to remove the acid.

### EXAMPLE 26

An emulsion was made in the same manner as in example 23. The emulsion was added to a glacial acetic acid using a spraying device as in example 14, to form micron size particles. The particles were left in the acid for few minutes and then filtered and washed with water and kept wet in water.

Using the beads and micron size particles made by the examples above, the amount of volatile material released to the atmosphere was measured resulting in the amounts outlined in Table 1.

TABLE 1

| | | | | | | weight of active |
|---|---|---|---|---|---|---|
| | | Wet Bead | Dry bead | Wet bead | Dry bead | ingredient |
| | | diameter | diameter | Weight | Weight | released |
| Sample | Example | (mm) | (mm) | (mg) | (mg) | (% of total) |
| A | 1 | 1.5-2 | 1-1.5 | 4-5 | 1-2 | 32 (after 63 days) |
| B | 2 | 1.5-2 | 1-1.5 | 4-5 | 1-2 | 45 (after 37 days) |
| C | 3 | 1.5-2 | 1-1.5 | 4-5 | 1-2 | 35 (after 37 days) |
| D | 4 | 1.5-2 | 1-1.5 | 4-5 | 1-2 | 10 (after 52 days) |
| E | 5 | 1.5-2 | 1-1.5 | 4-5 | 1-2 | 80 (after 52 days) |
| F | 6 | 1.5-2 | 1-1.5 | 4-5 | 1-2 | 75 (after 63 days) |
| G | 9 | 1-1.5 | 1 | 4-5 | 1-2 | 50 (after 42 days) |
| H | 10 | 1.5-2 | 1-1.5 | 4-5 | 1-2 | 40 (after 90 days) |
| I | 11 | 2-3 | 0.5-1 | 5 | 0.5-1 | 85 (after 21 days) |
| J | 14 | 0.005-0.1 | — | — | — | 90 (after 22 days) |
| K | 15 | 0.005-0.1 | — | — | — | 65 (after 37 days) |

TABLE 2

| | Average number of moths per trap per day | | | | | |
|---|---|---|---|---|---|---|
| | After | After | After | After | After | After |
| | 5 days | 7 days | 13 days | 24 days | 37 days | 43 days |
| Experiment | 0 | 3 | 1 | 2 | 0 | 3 |
| Control | 12 | 32 * | 9 | 42 * | 40 | 30 |

* The field was sprayed against PBW one day after the count

TABLE 3

Number of days

| | 0 | 5 | 10 | 15 | 22 | 35 |
|---|---|---|---|---|---|---|
| Percent released | 0 | 25 | 70 | 80 | 90 | 95 |
| 75 Bloom | | | | | | |
| Percent released | 0 | 18 | 35 | 40 | 50 | 70 |
| 225 Bloom | | | | | | |

TABLE 4
Average number of moths per trap per day

| | After 5 days | After 12 days | After 20 days |
|---|---|---|---|
| Experiment | 0 | 0 | 1 |
| Control | 7.5 | 16 | 25 |

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A method for sustained release of a volatile material comprising:
a) providing a water insoluble bead comprising droplets of an oil in water emulsion in a polymeric matrix, wherein the polymeric matrix comprises cross linked polymers, and at least one hydrophobic volatile component; and wherein said droplets comprise at least one surface active molecule;
b) exposing the bead to atmospheric air to cause sustained release of the volatile hydrophobic component.

2. The method according to claim 1, wherein the polymer matrix comprises at least one polymer selected from the group consisting of a protein, a polysaccharide, and a synthetic polymer.

3. The method according to claim 1, wherein the polymer matrix comprises a protein selected from the group consisting of gelatin, albumin, casein and lactoglobulin.

4. The method according to claim 1, wherein the polymer matrix comprises a polysaccharide and gelatin.

5. The method according to claim 4, wherein the polysaccharide is selected from the group consisting of sodium alginate, carraggenan, guar gum, locus bean gum, chitosan, pectin and carboxy methyl cellulose.

6. The method according to claim 1, wherein the surface active molecule is selected from the group consisting of ethoxylated sorbitan ester, alkyl ether and a block copolymer.

7. The method according to claim 1, wherein the bead is of a size between 5 and 80 microns.

8. The method according to claim 1, wherein the volatile component is selected from the group consisting of a pheromone, an essential oil, a pesticide, an attractant and an attractant inhibitor.

9. The method according to claim 8, wherein the volatile component is present in the bead in an amount of up to 50% wt/wt and is released from the water insoluble bead in atmospheric air over a period comprising a plurality of days.

10. The method according to claim 1, wherein the bead comprises tannic acid in an amount effective to provide a release rate of the volatile component from said bead in atmospheric air that is slower than a release rate of the volatile component from the bead in atmospheric air without the tannic acid.

11. A method for treating a volatile material comprising the steps of:
a) providing a water insoluble bead comprising droplets of an oil in water emulsion in a polymeric matrix, wherein the polymeric matrix comprises cross linked polymers, and at least one hydrophobic volatile component; and wherein said droplets comprise at least one surface active molecule;
b) storing the bead of (a) in water so as to prevent the release of the volatile component.

12. The method according to claim 1 1, wherein the polymer matrix comprises at least one polymer selected from the group consisting of a protein, a polysaccharide, and a synthetic polymer.

13. The method according to claim 11, wherein the polymer matrix comprises a protein selected from the group consisting of gelatin, albumin, casein and lactoglobulin.

14. The method according to claim 11, wherein the polymer matrix comprises a polysaccharide and gelatin.

15. The method according to claim 14, wherein the polysaccharide is selected from the group consisting of sodium alginate, carraggenan, guar gum, locus bean gum, chitosan, pectin and carboxy methyl cellulose.

16. The method according to claim 1 1, wherein the surface active molecule is selected from the group consisting of ethoxylated sorbitan ester, alkyl ether and a block copolymer.

17. The method according to claim 1 1, wherein the bead is of a size between 5 and 80 microns.

18. The method according to claim 11, wherein the volatile component is selected from the group consisting of a pheromone, an essential oil, a pesticide, an attractant and an attractant inhibitor.

19. A method for sustained release of a volatile material comprising:
a) providing a water insoluble bead comprising droplets of an oil in water emulsion in a polymeric matrix, wherein the polymeric matrix comprises cross linked polymers, and at least one hydrophobic volatile component; and wherein said droplets comprise at least one surface active molecule;
b) storing the bead of (a) in water so as to prevent the release of the volatile component; and
c) exposing the bead to atmospheric air thereby causing sustained release of the volatile hydrophobic component.

20. The method according to claim 19, wherein the volatile component is present in the bead in an amount of up to 50% wt/wt and is released from the water insoluble bead in atmospheric air over a period comprising a plurality of days.
